(19) United States
(12) Patent Application Publication
(10) Pub. No.: US 2013/0271564 A1
(43) Pub. Date: Oct. 17, 2013

(54) MOUNTAIN, NATURAL PARK TRACK VIEW WITH PANORAMAS TAKEN WITH AN ACQUISITION SYSTEM MOUNTED ON A BACKPACK

(71) Applicant: Fabio Zaffagnini, Fusignano (IT)

(72) Inventor: Fabio Zaffagnini, Fusignano (IT)

(21) Appl. No.: 13/648,629

(22) Filed: Oct. 10, 2012

Related U.S. Application Data
(60) Provisional application No. 61/545,471, filed on Oct. 10, 2011.

(51) Int. Cl. H04N 5/232

(52) U.S. Cl. CPC H04N 5/23238
USPC 348/38

(57) ABSTRACT

A device for the acquisition of the panoramic views regarding alternatively mountain trails, natural park trails, and/or hiking trails to be published on a web site including at least two cameras equipped with a memory device, a GPS logger, an electronic synchronizer device, a power supply system, and an aluminum rigid support mounted on a back pack. Additionally, a method to publish panoramic views regarding alternatively mountain natural park, generic-hiking trails on a website by processing the picture wherein the synchronized pictures with the related track saved into the GPS logger are stitched together into equirectangular panoramas, codified in HTML, JavaScript, Flex, Flash and then put on a website in a virtual reality format.

### RELATED APPLICATIONS

The present invention was first described in and claims the benefits of U.S. Provisional Application No. 61/545,471 filed on Oct. 10, 2011 the entirety of which is hereby incorporated by reference.

### FIELD OF THE INVENTION

The present invention relates to at least two cameras mounted on a backpack equipped with devices to publish on a website panoramic views regarding alternatively mountain trails, natural park, hiking trails.

### BACKGROUND OF THE INVENTION

Websites just publish static pictures of the landscapes with no possibility to interact like being inside a virtual environment turning and moving from one panorama to another.

The known website related to landscapes is google street view. However said website does not cover places accessible just on foot.

### SUMMARY OF THE INVENTION

People interested in hiking, nature, landscape currently do not have the possibility to have panoramic views of mountain or natural park trials. Those areas can be visited on foot only. The present invention has the purpose to have a website able to give the possibility to an end user of said website to see landscapes from the prospective of one who actually hikes the trail in a virtual reality format where every move and turn can be viewed from any angle. This means the end user can virtually turn in every directions, zoom, move back and forth and see how the landscape is like. Furthermore it is possible to get information from the selected trail, like name, length, difficulty eventually commercial and tourist facilities inside the panoramas. A line or an arrow indicated in the truck tells the end user where he can go. The website can be accessible also by a cell phone or a tablet. In such a case the website can also suggests the hikers the right way to follow if the trail is not clearly signed, giving some help if the hikers go lost indicating where there are and which is the right way.

Said purposes are obtained by a device for the acquisition of panoramic views regarding alternatively mountain trails, natural park trails, hiking trails to be published on a website comprising at least two cameras equipped with a memory device, a GPS logger, an electronic synchronizer device, a power supply system, an aluminum rigid support mounted on a back pack.

Said panoramic views are acquired by an operator equipped with the device subject to the present invention. Said operator starts walking along the trail and the cameras have an intervallometer programmed by the operator that allows an automatic shooting of the cameras at fixed time intervals. Said intervallometer can also be programmed by the manufacturer of the device subject to the present invention.

The intervallometer is preferable programmed in order to shot a picture minimum every 20 meters and maximum 30 meters. All the images are stored in the cameras memory device and in the meantime the GPS logger records the track and the way point corresponding to every shot.

The cameras have also a device connected to the GPS logger programmed by the operator that allows an automatic shooting of the cameras at a fixed space intervals. Said device connected to the GPS logger can also be programmed by the manufacturer of the device subject to the present invention.

The shooting of the cameras can also be made by the operator manually disabling the programmed devices for automatic shooting.

The cameras can be equipped with a wide angle lens. Said equipped cameras fixed at the rigid aluminum support are able to obtain pictures covering 360° horizontally and about 270° vertically.

The device subject to the present invention has an electronic synchronizer device able to link each photo stored in the camera memory to the related track and to the waypoint recorded in the GPS logger, saving the synchronized pictures with the related track and the related waypoints into the GPS logger. The electronic synchronizer device is also able to link each photo stored in the camera memory to the related track only or to the related waypoints only.

The device has also an acquisition system kept vertically by the use of a spherical joint and counterbalanced by the power supply system to avoid the acquisition system tilt.

In order to reach the purpose of the present invention, during the post-processing procedure, the pictures are stitched together into equirectangular panoramas, in other words one panorama per shoot. Each panorama refers to a couple of coordinates and the angle of orientation and codified in HTML, JavaScript, Flex, Flash, having a final result a website interface that gives the possibility to view the panoramas in a virtual-reality-like environment. The interface permits to view just a part of the panorama and gives the impression to turn in every direction. It is possible to zoom and to move from one panorama to another, going back and forth. Inside this interface there is a line indicating the direction of the trail and a map indicating the trail and the position of the end user.

Therefore the method applied to publish panoramic views regarding alternatively mountain, natural park, generic-hiking trails on a website by processing the pictures obtained using the device above mentioned is made by synchronizing said pictures with the related track saved into the GPS logger and stitching them together into equirectangular panoramas, codifying them in HTML, JavaScript, Flex, Flash and putting them on the website in a virtual reality format

The pictures can also be synchronized with the related waypoints saved into the GPS logger or with the related track and waypoints saved into the GPS logger.

### BRIEF DESCRIPTION OF THE DRAWING

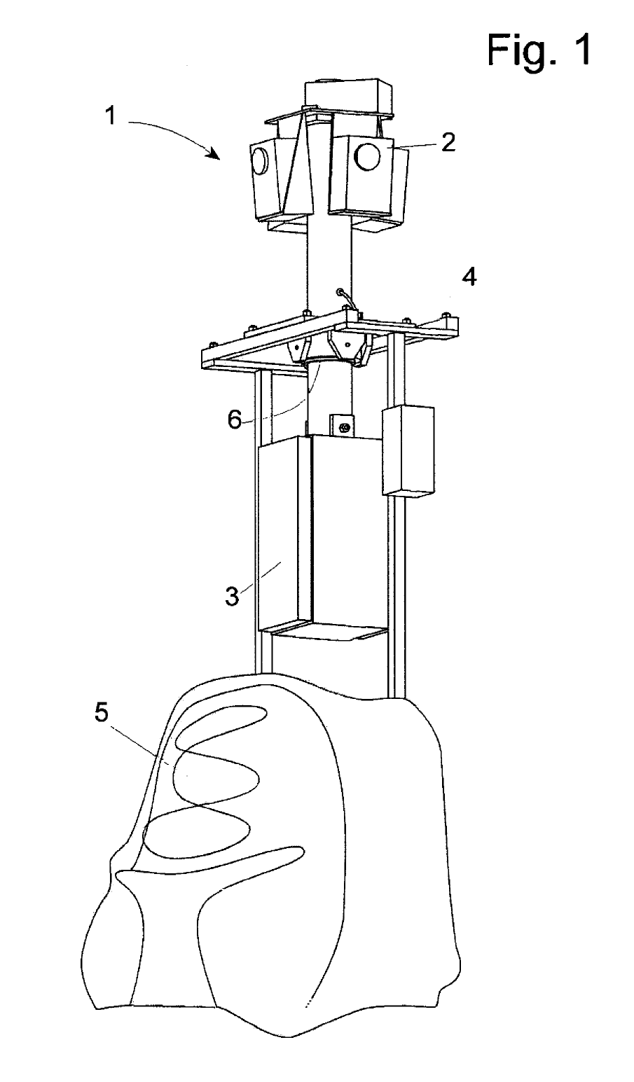

The FIG. 1 shows a prospective view of the device subject to the present invention in which the device (1) for the acquisition of the panoramic views regarding alternatively mountain trails, natural park trails, hiking trails to be published on a website has at least two cameras (2) equipped with a memory device, which is not shown, as well as a GPS logger, an electronic synchronizer device. Said device (1) has also a power supply system (3), an aluminum rigid support (4) mounted on a back pack (5). The cameras (2) have an intervallometer, which is not shown, programmed by the operator or by the manufacturer that allows an automatic shooting of the cameras at fixed time intervals. The cameras (2) can also have a device, which is not shown, connected to the GPS logger programmed by the operator or by the manufacturer that allows an automatic shooting of the cameras at fixed space intervals. Said electronic synchronizer device, which is not show, is able to link each photo stored in the camera memory to the related track and the waypoint recorded in the GPS logger, saving the synchronized pictures with the related track and the waypoints into the GPS logger. It is also able to link each photo stored in the camera memory to the related track and the waypoint recorded in the GPS logger, saving the synchronized pictures with the related track into the GPS logger or saving the synchronized pictures with the waypoints into the GPS logger.

The device (1) is kept vertically by the use of a spherical joint (6) and is counterbalanced by the power supply system (3) in order not to make the acquisition system tilt.

What is claimed is:

1. A device for the acquisition of the panoramic views regarding alternatively mountain trails, natural park trails, hiking trails to be published on a website comprising at least two cameras equipped with a memory device, a GPS logger, an electronic synchronizer device, a power supply system, an aluminum rigid support mounted on a back pack.

2. The device according to claim 1 wherein the cameras have an intervallometer programmed by the operator or by the manufacturer that allows an automatic shooting of the cameras at fixed time intervals.

3. The device according to claim 1 wherein the cameras have a device connected to the GPS logger programmed by the operator or by the manufacturer that allows an automatic shooting of the cameras at fixed space intervals.

4. The device according to claim 1 wherein the electronic synchronizer device is able to link each photo stored in the camera memory to the related track and the waypoint recorded in the GPS logger, saving the synchronized pictures with the related track and the waypoints into the GPS logger.

5. The device according to claim 1 wherein the electronic synchronizer device is able to link each photo stored in the camera memory to the related track and the waypoint recorded in the GPS logger, saving the synchronized pictures with the related track into the GPS logger.

6. The device according to claim 1 wherein the electronic synchronizer device is able to link each photo stored in the camera memory to the related track and the waypoint recorded in the GPS logger, saving the synchronized pictures with the waypoints into the GPS logger.

7. The device according to claim 1 wherein the acquisition system is kept vertical thanks to the use of a spherical joint and is counterbalanced by the power supply system in order not to make the acquisition system tilt.

8. Method to publish panoramic views regarding alternatively mountain natural park, generic-hiking trails on a website by processing the picture wherein the synchronized pictures with the related track saved into the GPS logger are stitched together into equirectangular panoramas, codified them in HTML, JavaScript, Flex, Flash putting them on the website in a virtual reality format.

9. Method according to claim 1 wherein the pictures are synchronized with the related waypoints saved into the GPS logger.

10. Method according to claim 1 wherein the pictures are synchronized with the related track and waypoints saved into the GPS logger.

11. The device according to claim 2 wherein the electronic synchronizer device is able to link each photo stored in the camera memory to the related track and the waypoint recorded in the GPS logger, saving the synchronized pictures with the related track and the waypoints into the GPS logger.

12. The device according to claim 3 wherein the electronic synchronizer device is able to link each photo stored in the camera memory to the related track and the waypoint recorded in the GPS logger, saving the synchronized pictures with the related track and the waypoints into the GPS logger.

13. The device according to claim 2 wherein the electronic synchronizer device is able to link each photo stored in the camera memory to the related track and the waypoint recorded in the GPS logger, saving the synchronized pictures with the related track into the GPS logger.

14. The device according to claim 3 wherein the electronic synchronizer device is able to link each photo stored in the camera memory to the related track and the waypoint recorded in the GPS logger, saving the synchronized pictures with the related track into the GPS logger.

15. The device according to claim 4 wherein the electronic synchronizer device is able to link each photo stored in the camera memory to the related track and the waypoint recorded in the GPS logger, saving the synchronized pictures with the related track into the GPS logger.

16. The device according to claim 2 wherein the electronic synchronizer device is able to link each photo stored in the camera memory to the related track and the waypoint recorded in the GPS logger, saving the synchronized pictures with the waypoints into the GPS logger.

17. The device according to claim 3 wherein the electronic synchronizer device is able to link each photo stored in the camera memory to the related track and the waypoint recorded in the GPS logger, saving the synchronized pictures with the waypoints into the GPS logger.

18. The device according to claim 4 wherein the electronic synchronizer device is able to link each photo stored in the camera memory to the related track and the waypoint recorded in the GPS logger, saving the synchronized pictures with the waypoints into the GPS logger.

19. The device according to claim 2 wherein the acquisition system is kept vertical thanks to the use of a spherical joint and is counterbalanced by the power supply system in order not to make the acquisition system tilt.

20. The device according to claim 3 wherein the acquisition system is kept vertical thanks to the use of a spherical joint and is counterbalanced by the power supply system in order not to make the acquisition system tilt.
